(19) United States
(12) Patent Application Publication
(10) Pub. No.: US 2021/0071864 A1
(43) Pub. Date: Mar. 11, 2021

(54) Preheating Combustion Air With Gasification Furnace Flue Gas

(71) Applicant: Saudi Arabian Oil Company, Dhahran (SA)

(72) Inventors: Yasir H. Abbasi, Dhahran (SA); Dhawi A. Al-Otaibi, Dhahran (SA); Mohammed S. Al Robai, Dhahran (SA)

(21) Appl. No.: 16/567,289

(22) Filed: Sep. 11, 2019

(51) Int. Cl. F23G 5/46; F23L 15/04; F27D 17/00

(52) U.S. Cl. CPC F23G 5/46; C01B 2203/1241; F27D 17/004; F23L 15/04

(57) ABSTRACT

To preheat combustion air with gasification furnace flue gas, combustion air is flowed towards an inlet of a gasification furnace. The combustion air is heated using flue gas emitted from the gasification furnace. The flue gas is generated within the gasification furnace responsive to a gasification process. The heated combustion air is flowed into the inlet of the gasification furnace. The gasification process is implemented within the gasification furnace using the heated combustion air

### TECHNICAL FIELD

This disclosure relates to gasification furnaces used, for example, to heat process streams in petro-chemical operations.

### BACKGROUND

Hydrocarbons trapped in subsurface reservoirs can be produced through wellbores formed from the surface of the Earth to the subsurface reservoirs. The produced (or recovered) hydrocarbons, for example, crude oil, are in an unrefined state and need to be processed, for example, in a crude oil processing plant. Typically, such a plant includes several hydrocarbon processing systems through which the hydrocarbons flow during different stages of crude oil processing. Gasification furnaces are implemented in some or all of the hydrocarbon processing systems to process and refine the hydrocarbons into useable commodities, for example, gasoline, diesel, water, sulfur, to name a few.

### SUMMARY

This specification describes technologies relating to preheating combustion air with gasification furnace flue gas.

Certain aspects of the subject matter described here can be implemented as a method. Combustion air is flowed towards an inlet of a gasification furnace. The combustion air is heated using flue gas emitted from the gasification furnace. The flue gas is generated within the gasification furnace responsive to a gasification process. The heated combustion air is flowed into the inlet of the gasification furnace. The gasification process is implemented within the gasification furnace using the heated combustion air.

An aspect combinable with any of the other aspects includes the following features. To heat the combustion air using the flue gas, the combustion air and the flue gas are flowed through a heat exchanger. Heat of the flue gas is transferred to the combustion air within the heat exchanger.

An aspect combinable with any of the other aspects includes the following features. The heat exchanger is a shell and tube heat exchanger. The flue gas is flowed through the shell and the combustion air is flowed through the tube of the shell and tube heat exchanger.

An aspect combinable with any of the other aspects includes the following features. To heat the combustion air using the flue gas, the combustion air is flowed through the heat exchanger in a counterclockwise direction.

An aspect combinable with any of the other aspects includes the following features. Prior to heating the combustion air using the flue gas, a temperature of the combustion air is substantially 20° C. After heating the combustion air using the flue gas, the temperature of the combustion air is substantially 100° C.

An aspect combinable with any of the other aspects includes the following features. The flue gas emitted by the gasification furnace includes solid particles. Prior to heating the combustion air using the flue gas emitted from the gasification furnace, the flue gas is flowed through a cyclonic separator, and the solid particles are separated from the flue gas in the cyclonic separator.

An aspect combinable with any of the other aspects includes the following features. Prior to heating the combustion air using the flue gas, a temperature of the flue gas is substantially 350° C. After heating the combustion air using the flue gas, the temperature of the flue gas is substantially 150° C.

Certain aspects of the subject matter described here can be implemented as a system. A gasification furnace is configured to combust combustion air using hydrocarbon fuel to produce flue gas. The gasification furnace includes an inlet to receive the combustion air and an outlet to emit the flue gas. A heat exchanger is fluidically coupled to the gasification furnace. The heat exchanger is configured to receive the flue gas emitted through the outlet of the gasification furnace, receive the combustion air flowed toward the inlet of the gasification furnace, transfer heat carried by the flue gas to the combustion air and flow the heated combustion air into the inlet of the gasification furnace.

An aspect combinable with any of the other aspects includes the following features. The heat exchanger is positioned outside the gasification furnace.

An aspect combinable with any of the other aspects includes the following features. The flue gas emitted by the gasification furnace includes solid particles. The system includes a cyclonic separator fluidically coupled to the outlet of the gasification furnace. The cyclonic separator is configured to receive the flue gas and to separate the solid particles from the flue gas. The cyclonic separator is fluidically coupled to the heat exchanger and is configured to flow the flue gas separated from the solid particles to the heat exchanger.

An aspect combinable with any of the other aspects includes the following features. Prior to heating the combustion air using the flue gas, a temperature of the combustion air is substantially 20° C. After heating the combustion air using the flue gas, the temperature of the combustion air is substantially 100° C.

An aspect combinable with any of the other aspects includes the following features. Prior to heating the combustion air using the flue gas, a temperature of the flue gas is substantially 350° C. After heating the combustion air using the flue gas, the temperature of the flue gas is substantially 150° C.

An aspect combinable with any of the other aspects includes the following features. A fan flows the combustion air into the heat exchanger.

An aspect combinable with any of the other aspects includes the following features. A first fluidic flow pathway fluidically couples the heat exchanger to the inlet of the gasification furnace. A second fluidic flow pathway fluidically couples the outlet of the gasification furnace to the heat exchanger.

Certain aspects of the subject matter described here can be implemented as a system. A gasification furnace is configured to combust combustion air using hydrocarbon fuel to produce flue gas. A heat exchanger is fluidically coupled to the gasification furnace and positioned outside the gasification furnace. The heat exchanger is configured to transfer heat carried by the flue gas to the combustion air before the combustion air enters the gasification furnace, and flow the heated combustion air into the inlet of the gasification furnace.

An aspect combinable with any of the other aspects includes the following features. The flue gas produced by the gasification furnace includes solid particles. A cyclonic separator is fluidically coupled to the gasification furnace. The cyclonic separator is configured to receive the flue gas and to separate the solid particles from the flue gas. The cyclonic separator is fluidically coupled to the heat exchanger and is configured to flow the flue gas separated from the solid particles to the heat exchanger.

An aspect combinable with any of the other aspects includes the following features. A first fluidic flow pathway fluidically couples the heat exchanger to the inlet of the gasification furnace. A second fluidic flow pathway fluidically couples the outlet of the gasification furnace to the heat exchanger.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic of an example of a system for preheating combustion air used in a gasification furnace.

FIG. 2 is a schematic of an example of a system for preheating combustion air used in multiple gasification furnaces.

FIG. 3 is a flowchart of an example of a process of implementing the system of FIG. 1.

Like reference numbers and designations in the various drawings indicate like elements.

### DETAILED DESCRIPTION

Gasification furnaces are fired equipment that transfer heat of combustion of fuel to processes that require heating, for example, processing of crude oil. Sometimes, gasification furnaces are used when radiant heat transfer is needed due to the demand for high temperature heating or high heat flux, for example, reactions with short residence times. An example of a gasification furnace includes a radiant zone and convective zone. In the radiant zone, heat is transferred mainly by radiation from the flame to the tubes carrying the process fluid. Heat transfer in this zone features high heat transfer rates due to radiation. In the convective zone, the remaining heat of combustion is available from hot flue gases leaving the radiant zone. Heat in the flue gases can be used in application such as heating process streams of crude oil refining processes. In this zone, heat transfer is achieved through convection as the flue gases pass through the tubes carrying the process fluid. One example implementation of gasification furnaces includes multiple hearth furnaces installed to utilize air at substantially 20 degree Celsius (° C.) for combustion with propane or butane fuel. These furnaces emit flue gases at temperatures of substantially 600° C. In this disclosure, the use of the term “substantially” to qualify a temperature value represents a permissible variation of the actual temperature to be within 90% and 110% of the mentioned temperature value. Thus, “substantially 20° C.” means that the actual temperature can range between 18° C. and 22° C. Similarly, “600° C.” means that the actual temperature can range between 540° C. and 660° C.

This disclosure describes preheating the combustion air with heat carried by the flue gases before the combustion air enters the gasification furnace. Such preheating can increase the temperature of the combustion air, sometimes, by a factor of 4 (for example, from substantially 20° C. to 80° C.) or more. The heated combustion air is then sent into the gasification furnace to burn the fuel (for example, propane or butane). The gasification furnace can operate at increased efficiency (for example, substantially 15% increase) and reduced fuel consumption (for example, substantially 10% reduction, which can translate to substantially 900,000 kilograms per year). The temperature of the flue gases emitted by the gasification furnace can be decreased due to the heat transfer to heat the combustion air. Reduced temperature of the flue gases can decreased environmental emissions such as NOR, SOX and CO₂ gases. Reduced temperature of the flue gases can also increase the life and integrity of the stacks through which the gases are flowed. Cost of material selection of downstream equipment, for example, filter house, cyclone, duct, stack, due to low flue gas temperature can be optimized and reduced.

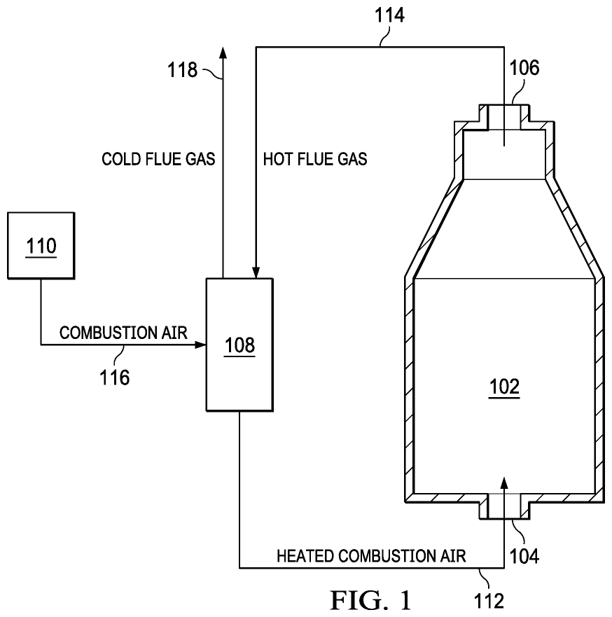

FIG. 1 is a schematic of an example of a system for preheating combustion air used in a gasification furnace 102. The gasification furnace 102 can combust combustion air using hydrocarbon fuel (for example, propane, butane) to produce heat which can be used in applications such as crude oil processing. An output of the combustion is flue gases at temperatures as high as substantially 350° C. The gasification furnace 102 includes an inlet 104 into which the combustion air is flowed and an outlet 106 through which the flue gases are released. In some implementations, a heat exchanger 108 is fluidically coupled to the gasification furnace 102. The heat exchanger 108 can receive the flue gas emitted through the outlet 106 of the gasification furnace 102 and receive combustion air flowed toward the inlet of the gasification furnace 102. The heat exchanger 108 can transfer heat carried by the flue gas to the combustion air. The heat exchanger 108 can flow the heated combustion air into the inlet 104 of the gasification furnace 102. In this manner, the heat exchanger 108 is implemented to preheat the combustion air before the combustion air enters the gasification furnace 102.

In some implementations, the combustion air can be generated by a fan 110 that is fluidically coupled to the heat exchanger 108. For example, the fan can be a forced draft fan that provides a positive pressure. The fan 110 is force draft with permanent blade pitch with two speed motor for better turndown and temperature control. The fan 110 flows the combustion air to the heat exchanger 108 through a fluidic flow pathway. The fan 110 is upstream of the heat exchanger 108. In some implementations, a second force draft fan (not shown) can be fluidically coupled downstream of the heat exchanger 108. The fan 110 can force the clean air (combustion air) from atmosphere into the heat exchanger 108 and then into the gasification furnace 102. The second fan, which is downstream of the heat exchanger, can push the cold flue gas from the heat exchanger 108 into the atmosphere. The heat exchanger 108 is positioned outside the gasification furnace 102. In some implementations, the heat exchanger 108 is a shell and tube heat exchanger. The flue gases are flowed in the shell side of the heat exchanger 108 and the combustion air is flowed in the tube side of the heat exchanger 108.

By “fluidic coupling,” it is meant that fluids (for example, gases, liquids or combinations of them) can flow between the coupled entities. Fluidic coupling can be implemented using fluid flow pathways, for example, tubes, pipes or similar structures through which gases, liquids or combinations of them can be flowed at different temperatures, pressures or both. In addition to being temperature and pressure resistant, such pathways can be corrosion resistant or otherwise capable of carrying the fluids flowed through them while maintaining structural integrity. In the schematic shown in FIG. 1, the combustion air is flowed from the fan 110 to the heat exchanger 108 through the fluidic flow pathway 112. Heated combustion air is flowed from the heat exchanger 108 to the inlet 104 of the gasification furnace 102 through the fluidic flow pathway 112. Flue gas is flowed from the outlet 106 of the gasification furnace 102 to the heat exchanger 108 through the fluidic flow pathway 114. Following the heat exchange, the cold flue gas can be flowed away from the heat exchanger 108 through the fluidic flow pathway 118.

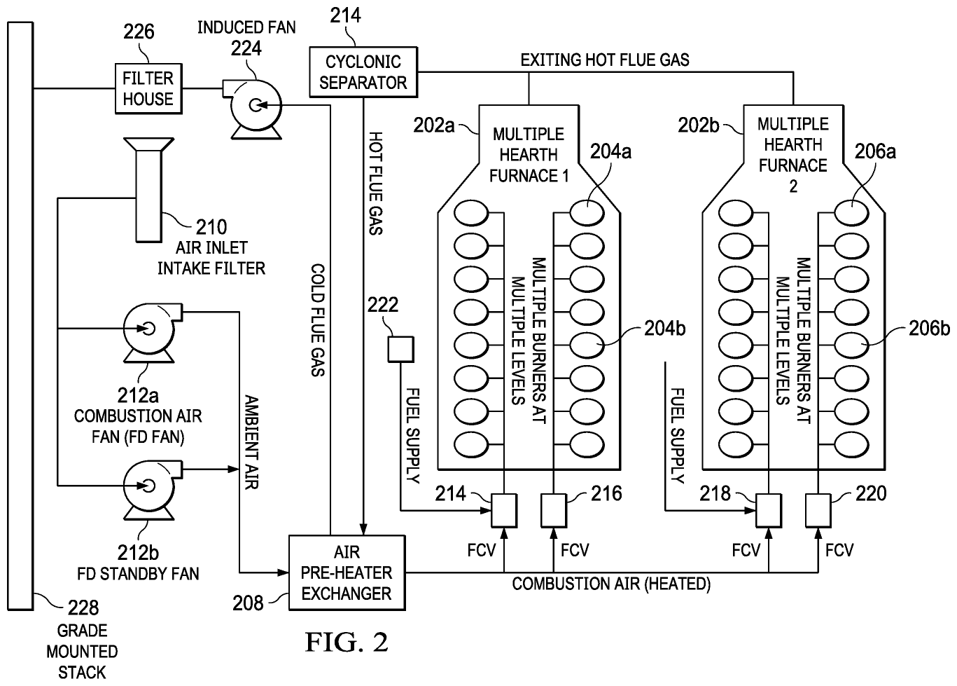

FIG. 2 is a schematic of an example of a system for preheating combustion air used in multiple gasification furnaces similar to the gasification furnace 102, for example, hearth furnaces 202a, 202b. Each furnace includes multiple burners (for example, burners 204a, 204b in furnace 202a, burners 206a, 206b in furnace 202b) at different levels within the furnaces. For example, each furnace can include 57 burners at 17 levels. An air preheater exchanger 208 can be positioned outside of and fluidically coupled to both furnaces. Similar to the heat exchanger 108 described earlier, the preheater exchanger 208 can receive flue gases emitted by each of the furnaces 202a, 202b and combustion air, transfer heat carried by the flue gases to the combustion air, and flow the heated combustion air to the inlets of each of the furnaces 202a, 202b. Cold flue gases exiting the preheater exchanger 208 can be drawn by a fan 224. The fan 224 flows the cold flue gases through a filter house 226 which filters the cold flue gases. The filtered cold flue gases are then released into the atmosphere through a grade mounted stack 228. In some implementations, the hot flue gas from the furnace outlet can enter a cyclonic separator 214, which can induce a spiral flow of the hot flue gas within the cyclonic separator housing. The spiral flow can separate the solid particles in the hot flue gas from the gas prior to the hot flue gas flowing into the heat exchanger 208, the filter house and finally into stack to release flue gas into atmosphere.

Combustion air can be flowed to the preheater exchanger 208. For example, air can be fed through an air inlet intake filter 210 and flowed to each furnace by one or more combustion air fans (for example, fan 212a or fan 212b or both or additional fans). As described earlier, the preheater exchanger 208 heats the combustion air flowed by the air fan (or fans) using heat carried by the flue gases emitted by the furnaces. The heated combustion air flowed to the inlets of the furnaces 202a, 202b. Fuel (for example, propane, butane or similar fuel) can be flowed to the furnaces 202a, 202b from a fuel reservoir 222. Flow control valves (for example, valves 216, 216, 218, 220) control flow of the different fluids into the gasification furnace. Similarly, flow control valves (not shown) control flow of the flue gases from the furnaces to the preheater exchanger 208.

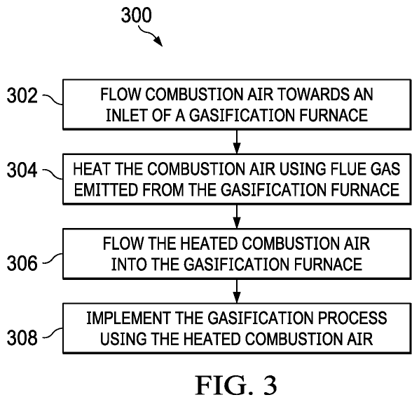

FIG. 3 is a flowchart of an example of a process 300 of implementing the system of FIG. 1. At 302, combustion air is flowed towards an inlet of a gasification furnace. At 304, the combustion air is heated using flue gas emitted from the gasification furnace. At 306, the heated combustion air is flowed into the gasification furnace. At 308, the gasification process is implemented using the heated combustion air. In some implementations, prior to heating the combustion air using the flue gas, a temperature of the combustion air and a temperature of the flue gas is substantially 20° C. and 350° C., respectively. After heating the combustion air using the flue gas, the temperature of the combustion air and the temperature of the flue gas is substantially 100° C. and 150° C., respectively.

The quantity of flue gas flowed from the outlet of the gasification furnace to the heat exchanger can be all or a portion of the flue gas emitted by the gasification furnace. The quantity of flue gas can be selected based on a desired quantity by which the combustion air is to be preheated.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
flowing combustion air towards an inlet of a gasification furnace;
heating the combustion air using flue gas emitted from the gasification furnace, the flue gas generated within the gasification furnace responsive to a gasification process;
flowing the heated combustion air into the inlet of the gasification furnace; and
implementing the gasification process within the gasification furnace using the heated combustion air.

2. The method of claim 1, wherein heating the combustion air using the flue gas comprises flowing the combustion air and the flue gas through a heat exchanger, wherein heat of the flue gas is transferred to the combustion air within the heat exchanger.

3. The method of claim 2, wherein the heat exchanger is a shell and tube heat exchanger, wherein the method further comprises:
flowing the flue gas through the shell of the shell and tube heat exchanger; and
flowing the combustion air through the tube of the shell and tube heat exchanger.

4. The method of claim 2, wherein heating the combustion air using the flue gas comprises flowing the combustion air through the heat exchanger in a counterclockwise direction.

5. The method of claim 1, wherein, prior to heating the combustion air using the flue gas, a temperature of the combustion air is substantially 20° C., and wherein, after heating the combustion air using the flue gas, the temperature of the combustion air is substantially 100° C.

6. The method of claim 1, wherein the flue gas emitted by the gasification furnace comprises solid particles, wherein the method further comprises, prior to heating the combustion air using the flue gas emitted from the gasification furnace:
flowing the flue gas through a cyclonic separator; and
separating, in the cyclonic separator, the solid particles from the flue gas.

7. The method of claim 1, wherein, prior to heating the combustion air using the flue gas, a temperature of the flue gas is substantially 350° C.

8. The method of claim 7, wherein, after heating the combustion air using the flue gas, the temperature of the flue gas is substantially 150° C.

9. A system comprising:
a gasification furnace configured to combust combustion air using hydrocarbon fuel to produce flue gas, the gasification furnace comprising:
an inlet to receive the combustion air, and
an outlet to emit the flue gas; and
a heat exchanger fluidically coupled to the gasification furnace, the heat exchanger configured to:
receive the flue gas emitted through the outlet of the gasification furnace,
receive the combustion air flowed toward the inlet of the gasification furnace,
transfer heat carried by the flue gas to the combustion air, and
flow the heated combustion air into the inlet of the gasification furnace.

10. The system of claim 9, wherein the heat exchanger is positioned outside the gasification furnace.

11. The system of claim 9, wherein the flue gas emitted by the gasification furnace comprises solid particles, wherein the system comprises a cyclonic separator fluidically coupled to the outlet of the gasification furnace, the cyclonic separator configured to receive the flue gas and to separate the solid particles from the flue gas, the cyclonic separator fluidically coupled to the heat exchanger, the cyclonic separator configured to flow the flue gas separated from the solid particles to the heat exchanger.

12. The system of claim 9, wherein, prior to heating the combustion air using the flue gas, a temperature of the combustion air is substantially 20° C.

13. The system of claim 12, wherein, after heating the combustion air using the flue gas, the temperature of the combustion air is substantially 100° C.

14. The system of claim 9, wherein, prior to heating the combustion air using the flue gas, a temperature of the flue gas is substantially 350° C.

15. The system of claim 14, wherein, after heating the combustion air using the flue gas, the temperature of the flue gas is substantially 150° C.

16. The system of claim 9, further comprising a fan configured to flow the combustion air into the heat exchanger.

17. The system of claim 9, further comprising:
a first fluidic flow pathway fluidically coupling the heat exchanger to the inlet of the gasification furnace; and
a second fluidic flow pathway fluidically coupling the outlet of the gasification furnace to the heat exchanger.

18. A system comprising:
a gasification furnace configured to combust combustion air using hydrocarbon fuel to produce flue gas; and
a heat exchanger fluidically coupled to the gasification furnace and positioned outside the gasification furnace, the heat exchanger configured to:
transfer heat carried by the flue gas to the combustion air before the combustion air enters the gasification furnace, and
flow the heated combustion air into the inlet of the gasification furnace.

19. The system of claim 18, wherein the flue gas produced by the gasification furnace comprises solid particles, wherein the system comprises a cyclonic separator fluidically coupled to the gasification furnace, the cyclonic separator configured to receive the flue gas and to separate the solid particles from the flue gas, the cyclonic separator fluidically coupled to the heat exchanger, the cyclonic separator configured to flow the flue gas separated from the solid particles to the heat exchanger.

20. The system of claim 18, further comprising:
a first fluidic flow pathway fluidically coupling the heat exchanger to an inlet of the gasification furnace; and
a second fluidic flow pathway fluidically coupling an outlet of the gasification furnace to the heat exchanger.
